(19) United States
(12) Patent Application Publication
(10) Pub. No.: US 2007/0163260 A1
(43) Pub. Date: Jul. 19, 2007

(54) Method for converting thermal energy into mechanical work

(76) Inventors: Steve Hargreaves, Broadbeach (AU); Franz-Peter Jegel, Steyr-Gleink (AT); Bernd Pfeifer, Graz (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/649,366

(22) Filed: Jan. 4, 2007

(30) Foreign Application Priority Data
Jan. 10, 2006 (AT) A 32/2006

(51) Int. Cl. F03G 6/00; F01K 25/02

(52) U.S. Cl. 60/650; 60/641.8

(57) ABSTRACT

The present invention relates to a method for converting thermal energy into mechanical work with the following steps:
supply of a hot heat transfer medium to a first working chamber of a first heat exchanger (1a); isochoric heating of a first quantity of a working medium in a second working chamber of the first heat exchanger by the heat transfer medium; repeated performance of the following sub-steps:
   allowing the transfer flow of at least a partial quantity of the first quantity of the working medium from the second working chamber (3a; 3b) of the first heat exchanger or the preceding heat exchanger to a second working chamber (3b; 3c) of a further subsequent heat exchanger (1b; 1c);
   isochoric heating of the transferred partial quantity of the first quantity of a working medium in the second working chamber (3b; 3c) of the further subsequent heat exchanger (1b; 1c) by a heat transfer medium present in a first working chamber (2b; 2c) of the further subsequent heat exchanger (1b; 1c);
connecting the second working chamber (3c) of the further last heat exchanger (1c) with a pneumo-hydraulic converter (17) and ejection of a hydraulic medium from the converter (17) by the pressure of the working medium. High efficiency with a high flexibility can thus be achieved. The present invention further relates to an apparatus for performing the method.

The present invention relates to a method for converting thermal energy into mechanical work.

Numerous types of cyclic processes and apparatuses are known which are used to convert thermal energy into mechanical work and subsequently optionally into electric current. They concern steam power processes, Sterling processes or the like. One possibility for using such methods is to increase the efficiency of internal combustion engines by making use of the waste heat. The problematic aspect is that the available temperature levels are relatively unfavorable because the cooling circulation of internal combustion engines usually works at temperatures which lie close to 100° C. There is a similar problem when heat from solar plants is to be transferred into mechanical work.

A special solution for such a thermal power process has been shown in WO 03/081011 A. This specification describes a method in which a hydraulic medium is pressurized by heating a working medium in several bladder accumulators, which medium is processed in an engine. Although such a method is principally functional it has been proven that the efficiency is low and the complexity of the machinery is relatively high in relationship to the quantity of energy that can be produced.

DE 32 32 497 A discloses a method and an apparatus for converting thermal energy into mechanical work in which hot heat transfer medium is conducted into a first working chamber of a heat exchanger, a first quantity of the working medium is heated in a second working chamber of the heat exchanger by the hot heat transfer medium, and the second working chamber of the heat exchanger is connected with a pneumo-hydraulic converter a hydraulic medium from the converter and ejected of by the pressure of the working medium. With this apparatus it is necessary to heat and cool the cylinder alternately which is time consuming due to the thermal capacity of the cylinder. The apparatus has therefore a limited efficiency.

U.S. Pat. No. 4,617,801 A shows a thermal powered engine with free moving pistons. Pneum-hydaulic converters are used to transfer pressure into the system. This apparatus has a complex structure and a limited efficiency.

Further solutions showing the transfer from heat into mechanical work are disclosed in U.S. Pat. No. 4,283,915 A, in GB 1 536 437 A and in U.S. Pat. No. 5,548,957 A. For all these solutions the above comments are valid.

It is the object of the present invention to provide a method of the kind mentioned above in such a way that even under thermally unfavorable preconditions it is possible to achieve a high efficiency, with the configuration of apparatuses being kept as simple as possible.

In accordance with the invention, such a method consists of the following steps:
Supply of a hot heat transfer medium to a first working chamber of a first heat exchanger;
isochoric heating of a first quantity of a working medium in a second working chamber of the first heat exchanger by the heat transfer medium;
repeated performance of the following sub-steps:
   Allowing the transfer flow of at least a partial quantity of the first quantity of the working medium from the second working chamber of the first heat exchanger or the preceding heat exchanger to a second working chamber of a further subsequent heat exchanger;
   Isochoric heating of the transferred partial quantity of the first quantity of a working medium in the second working chamber of the further subsequent heat exchanger by a heat transfer medium present in a first working chamber of the further subsequent heat exchanger;
Connecting the second working chamber of the further last heat exchanger with a pneumo-hydraulic converter and ejection of a hydraulic medium from the converter by the pressure of the working medium.

In a first step, the heat transfer medium which is heated by an internal combustion engine to 100° C. for example is introduced into a first working chamber of a first heat exchanger. Preferably, said first heat exchanger concerns a so-called bladder accumulator, which is a pressure container with two working chambers which are mutually separated by a flexible membrane. This means that the total volume of the two working chambers remains relatively constant, but that the individual volumes are variable however. A heat exchange can occur relatively easily between the media via the relatively large flexible membrane, which media are present in the first and in the second working chamber. The first heat exchanger could also be alternatively configured as a cylinder which comprises two working chambers which are separated by a piston, as long as the piston is configured in such a way that a heat exchange is easily possible. The heat transfer medium is introduced in said first step to such an extent into the first heat exchanger that the first working chamber reaches approximately half the total volume of the heat exchanger.

A working medium which is present in the second working chamber of the first heat exchanger is heated in a second step by the first heat transfer medium. It concerns the main part of the heating because obviously a certain heating will occur already during the supply of the heat transfer medium to the first working chamber. Said main part of the heating occurs in an isochoric manner, because all valves which allow access to the second working chamber are closed. As a result of the temperature increase in the second working chamber, the pressure of the working medium rises accordingly.

The second working chamber of the first heat exchanger is joined in a third step with the second working chamber of the second heat exchanger, so that the working medium can flow over to said working chamber. As a result of the relaxation, the transferred working medium cools off and heat transfer medium is simultaneously displaced from the first working chamber as a result of the increase in volume of the second working chamber of the second heat exchanger. This process continues until the first and the second working chamber of the second heat exchanger for example have a volume which is approximately equally large. After the closing of the respective valves, there is again an isochoric heating of the working medium in the second working chamber of the second heat exchanger, which represents the fourth step.

Two, three or more heat exchangers are switched successively depending on the embodiment of the method in accordance with the invention. In the case of the presence of only two heat exchangers, there will now be a connection of the second working chamber of the second heat exchanger with a pneumo-hydraulic converter in the fifth step, which converter is also preferably configured as a bladder accumulator. As a result of the expanding working medium, the hydraulic medium is ejected at high pressure from the pneumo-hydraulic converter in order to drive an engine for example.

In the case of embodiments of the method with three or more heat exchangers, the steps three and four of the method are repeated in a respectively frequent manner. Very high pressures of 200 bars to 300 bars can thus be achieved, so that very high efficiencies can be achieved. Efficiency can be increased especially in such a way that after establishing pressure compensation between the second working chamber of the preceding heat exchanger and the second working chamber of the subsequent heat exchanger further heat transfer medium is pressed into the preceding heat exchanger in order to transfer working medium from the second working chamber of the first heat exchanger or preceding heat exchanger to a second working chamber of a further subsequent heat exchanger. The use of mechanical work is obviously required in order to drive the working medium completely from the second working chamber of the respective heat exchanger after the transfer flow process. This additional requirement is offset by a higher energy yield, which respectively increases the efficiency. It is especially advantageous in this respect when the second working chambers of the heat exchangers are fully emptied.

In order to remove the cooled heat transfer medium from the first working chambers and thus to avoid efficiency losses, it is preferably provided that the first working chambers are completely emptied after running through the above steps. This occurs by introducing working medium into the second working chambers of the respective heat exchangers, which can occur in a virtually pressureless manner.

The relevant aspect is that the working medium is compressible. It is possible to use both a gaseous working medium as well as to provide a liquid/gas phase mixture. It is especially preferable when the working medium has a boiling point at ambient pressure which lies between 60° C. and −20° C.

An especially favorable embodiment of the method in accordance with the invention provides that several cyclic processes are performed in regular intervals in a time-shifted manner. This means cyclic fluctuations can be compensated as in a multi-cylinder internal combustion engine, and an evening of the pressure can be brought about especially in the hydraulic system.

The energy supplied to the hydraulic system can be used in different ways. A supply to a hydraulic network can occur for example in order to drive hydraulic engines. The generation of electric power via a generator is primarily provided, which generator is driven by a hydraulic engine.

Since a strong cooling occurs during the relaxation of the working medium from the second working chamber of the last heat exchanger, the process can be guided in such a way that relatively low temperatures occur at this point. This allows supplying refrigerating circulations in a respective manner, e.g. for storage halls, refrigerating devices and the like, so that additional benefits can thus be created.

The present invention also relates to an apparatus for converting thermal energy into mechanical work, comprising at least two heat exchangers which each comprise a first and second working chamber, with the first working chamber being connected to a source of a hot heat transfer medium.

In accordance with the invention, this apparatus is characterized in that the heat exchangers comprise second working chambers which can be connected among each other and with a source of a working medium, and that the second working chamber of a heat exchanger can be connected with a pneumo-hydraulic converter.

It is preferable in this respect when the heat exchangers, starting from the first heat exchanger, each have a smaller volume. An especially high efficiency can thus be achieved.

The invention is explained below in closer detail by reference to embodiments shown in the drawing, wherein

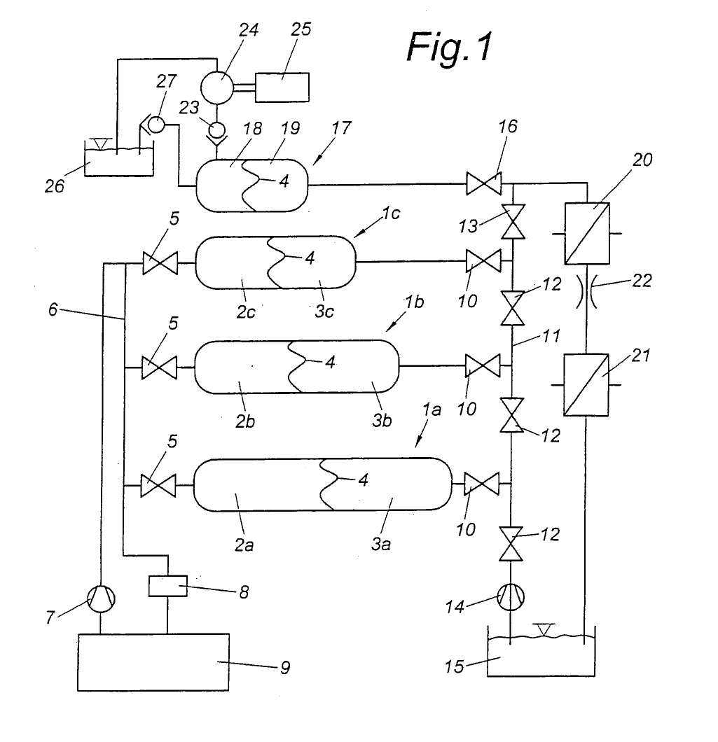

FIG. 1 shows a block diagram of an embodiment of the present invention

The apparatus in accordance with the invention consists of three heat exchangers 1a, 1b, 1c which are configured as bladder accumulators. Each heat exchanger 1a, 1b, 1c comprises a first working chamber 2a, 2b, 2c and a second working chamber 3a, 3b, 3c which are each separated from one another by a flexible membrane 4. As a result of the flexibility of the thin walled configuration of the membrane 4, it is ensured that always the same pressure and, at least after a short transitional period, substantially the same temperature prevail in the first or second working chamber 2a, 2b, 2c; 3a, 3b, 3c of each heat exchanger 1a, 1b, 1c. The first working chambers 2a, 2b, 2c of the heat exchangers 1a, 1b, 1c are connected via valves 5 with a line 6 in which the heat transfer medium circulates. Said heat transfer medium is circulated by a pump 7 and originates from an internal combustion engine 9 which uses the heat transfer medium as cooling water for example. A high-pressure pump (not shown here) may optionally also be provided in order to completely empty the second working chambers 3a, 3b, 3c of each heat exchanger 1a, 1b, 1c by pressing heat transfer medium into the first working chambers 2a, 2b, 2c of the heat exchangers 1a, 1b, 1c.

It is understood that other connections to an internal combustion engine are possible, e.g. by way of heat exchangers in order to also make use of the exhaust heat. In the course of the invention it is also possible to use other heat sources such as geothermal energy, solar energy or the like for the method in accordance with the invention. A buffer storage 8 is used for setting the respectively desired pressure.

The second working chambers 3a, 3b, 3c of the heat exchangers 1a, 1b, 1c are in connection via a valve 10 with a line 11 for a working medium, with further valves 12 being provided between the individual heat exchangers 1a, 1b, 1c. As an alternative it is possible to arrange the valves 10 as multiple-way valves. The working medium is conveyed by a pump 14 from a storage container 15. A pneumo-hydraulic converter 17 is in connection with line 11 via further valves 13 and 16, which converter comprises a hydraulic chamber 18 and a working chamber 19, which are also mutually separated by a flexible membrane 4.

The line 11 for the working medium continues after branching to the pneumo-hydraulic converter 17 via a first cooler 20 and a second cooler 21, between which a throttle 22 is arranged. The working medium is moved away to the storage container 15 after the second cooler 21. The hydraulic circulation which originates from the pneumo-hydraulic converter 17 consists of a first non-return valve 23 behind which a hydraulic motor 24 is provided which is connected with a generator 25 for generating electric power. Downstream of the hydraulic motor 24, the hydraulic medium is supplied to a storage container 26, from where it is guided back again to the pneumo-hydraulic converter 17 via a second non-return valve 27.

The system is configured to a maximum pressure of 250 bars, and the first heat exchanger 1a has a total volume of 200 liters. The second heat exchanger 1b has a total volume of 160 liters and the third heat exchanger 1c has a total volume of 120 liters. The pneumo-hydraulic converter 17 has a volume of 80 liters.

In the practical configuration, five of the apparatuses shown in FIG. 1 are arranged parallel next to one another and are operated in a time-shifted manner, as is the case for example in a five-cylinder internal combustion engine.

The method in accordance with the invention is now explained in closer detail by reference to the block diagram of FIG. 1.

In the initial state, the first working chambers 2a, 2b, 2c have minimal volume, which means that the membranes 4 are situated virtually completely on the side of the heat transfer medium and the second working chambers 3a, 3b, 3c make up virtually the entire inside volume of the heat exchangers 1a, 1b, 1c and are filled with working medium. The working medium in the first heat exchanger 1a substantially has ambient temperature and the pressure corresponds to an admission pressure of 5 bars for example which is maintained as the minimum pressure in the system.

The valve 5 which belongs to the first heat exchanger 1a is opened in a first step and hot heat transfer medium with a temperature of 100° C. for example is allowed to flow into the first working chamber 2a. The feed is ended once the membrane 4 is situated in a middle position, which means that the first and the second working chambers 2a, 3a have approximately the same volume. The excess working medium is returned to the storage container 15 through the first valve 10 which is associated with the first heat exchanger 1a. After reaching the middle position, the valves 5 and 10 are closed, so that the working medium in the second working chamber 3a is heated in an isochoric manner by the hot heat transfer medium in the first working chamber 2a. After establishing the temperature compensation after a few seconds, the working medium in the second working chamber 3a is present at a temperature of 80° C. and a pressure of 80 bars. In a third step, the valves 10 and 12 between the first heat exchanger 1a and the second heat exchanger 1b are opened, so that the working medium can flow over from the second working chamber 3a of the first heat exchanger 1a to the second working chamber 3b of the second heat exchanger 1b. The heat transfer medium is returned to line 6 through the valve 5 which is associated with the second heat exchanger 1b until the middle position of the membrane 4 has been reached approximately. All valves 5, 10, 12 are then closed and an isochoric heating of the working medium again takes place in the second working chamber 3b of the second heat exchanger 1b. The working medium has been cooled off to a temperature of 50° C. by the transfer-flow process prior to the heating and the pressure has dropped to 60 bars. After the isochoric heating the pressure is 120° C. and the temperature 85° C.

Subsequently, a further analogous transfer and heating process is performed between the second and third heat exchanger 1b and 1c. The working medium finally reaches a temperature of 90° C. at a pressure of 250 bars. After the last step the valves 10, 13 and 16 are opened between the third heat exchanger 1c and the pneumo-hydraulic converter 17, so that the working medium flows into the working chamber 19 of the pneumo-hydraulic converter 17. The hydraulic medium is thus guided over the first non-return valve 13 through the engine 24 in which the mechanical work is gained and by which the generator 25 is driven.

The solution in accordance with the invention not only allows gaining mechanical work and thus electric power, but it is also possible to gain refrigeration as required in the coolers 20 and 21. Optimal yield of refrigeration can be obtained when the working medium in cooler 20 is cooled off at high temperature to ambient temperature, so that extremely deep temperatures of −40° C. for example are present after the throttle 22 which can be used for refrigerating processes.

A special advantage of the method and apparatus in accordance with the invention is that as a result of different control it is possible to set a large bandwidth of operating parameters and it is thus possible to achieve a very high flexibility at high efficiency.

1. A method for converting thermal energy into mechanical work with the following steps:
supply of a hot heat transfer medium to a first working chamber of a first heat exchanger;
isochoric heating of a first quantity of a working medium in a second working chamber of the first heat exchanger by the heat transfer medium;
repeated performance of the following sub-steps:
allowing the transfer flow of at least a partial quantity of the first quantity of the working medium from the second working chamber of the first heat exchanger or the preceding heat exchanger to a second working chamber of a further subsequent heat exchanger;
isochoric heating of the transferred partial quantity of the first quantity of a working medium in the second working chamber of the further subsequent heat exchanger by a heat transfer medium-present in a first working chamber of the further subsequent heat exchanger;
connecting the second working chamber of the further last heat exchanger with a pneumo-hydraulic converter and ejection of a hydraulic medium from the converter by the pressure of the working medium.

2. A method according to claim 1, wherein after establishing pressure compensation between the second working chamber of the preceding heat exchanger and the second working chamber of the subsequent heat exchanger further heat transfer medium is pressed into the preceding heat exchanger in order to transfer working medium from the second working chamber of the first heat exchanger or preceding heat exchanger to a second working chamber of a further subsequent heat exchanger.

3. A method according to claim 2, wherein after establishing pressure compensation between the second working chamber of the first heat exchanger or the preceding heat exchanger and the second working chamber of the subsequent heat exchanger the second working chamber of the first heat exchanger or the preceding heat exchanger is emptied completely.

4. A method according to claim 1, the first working chambers of all heat exchangers are emptied after ending the ejection of hydraulic medium.

5. A method according to claim 1, wherein between two and four three steps of isochoric heating of the working medium are carried out.

6. A method according to claim 1, wherein the working medium is gaseous.

7. A method according to claim 1, wherein the working medium is present as a liquid/gas phase mixture.

8. A method according to claim 1, wherein the pressure of the working medium in the first heat exchanger is between 50 and 100 bars after isochoric heating.

9. A method according to claim 1, wherein the pressure of the working medium in the first heat exchanger is between 25 and 50 bars after establishing the pressure compensation.

10. A method according to claim 1, wherein the working medium has a boiling point at ambient pressure which lies between −60° C. and −20° C.

11. A method according to claim 1, wherein in regular intervals several cyclic processes are performed simultaneously in a time-shifted manner.

12. A method according to claim 11, wherein between three and seven cyclic processes are performed simultaneously.

13. A method according to claim 1, wherein the heat transfer medium is heated by the waste heat of an internal combustion engine, by solar energy or by geothermal energy.

14. A method according to claim 1, wherein the hydraulic medium is processed in an engine which is connected to a generator for generating electric power.

15. A method according to claim 1, wherein the working medium is relaxed after the ejection of the hydraulic medium in order to generate refrigeration.

16. An apparatus for converting thermal energy into mechanical work, comprising at least two heat exchangers which each comprise a first and a second working chamber with the first working chamber being connected with a source of a hot heat transfer medium, wherein the heat exchangers comprise second working chambers which can be connected among each other and with a source of a working medium and that the second working chamber of a heat exchanger can be connected with a pneumo-hydraulic converter.

17. An apparatus according to claim 16, wherein the heat exchangers are configured as bladder accumulators.

18. An apparatus according to claim 16, wherein a compressor is provided for the supply of heat transfer medium to the first working chambers of the heat exchangers.

19. An apparatus according to claim 16, wherein the pneumo-hydraulic converter is configured as a bladder accumulator.

20. An apparatus according to claim 16, wherein several groups consisting of heat exchangers and a pneumo-hydraulic converter are provided parallel with respect to each other.

21. An apparatus according to claim 20, wherein between three and seven groups consisting of heat exchangers and a pneumo-hydraulic converter are provided parallel with respect to each other.

22. An apparatus according to claim 16, wherein a heat exchanger can be connected with an engine which is connected to a generator for electric power generation.

23. An apparatus according to claim 16, wherein a heat exchanger can be connected with a refrigerating machine.

24. An apparatus according to claim 16, wherein the circulation of the heat transfer medium is connected with an internal combustion engine, with a solar plant or a plant for utilizing geothermal energy which heats the heat transfer medium.

25. An apparatus according to claim 16, wherein the first heat exchanger has a larger volume than the subsequent heat exchanger and every further heat exchanger on its part has a larger volume than the respective subsequent heat exchanger.
